(19) United States
(12) Patent Application Publication
(10) Pub. No.: US 2010/0237729 A1
(43) Pub. Date: Sep. 23, 2010

(54) MOTION CONVERSION DEVICE

(76) Inventor: William J. Lawson, Milton, DE (US)

Correspondence Address: HOLLSTEIN KEATING CATTELL JOHNSON & GOLDSTEIN P.C., WILLOW RIDGE EXECUTIVE OFFICE PARK, 750 ROUTE 73 SOUTH, SUITE 301, MARLTON, NJ, 08053, US

(21) Appl. No.: 12/011,130

(22) Filed: Jan. 24, 2008

(51) Int. Cl. H02K 7/075

(52) U.S. Cl. 310/80

(57) ABSTRACT

A permanent magnet rotational motor employs the use of a rotating iron band member which absorbs the magnetic flux of both of the opposing magnet flux fields from stator and rotor magnets. This causes mutually opposing, interacting magnetic flux fields of the rotor and stator magnets to enter in close proximity to one another without opposition. This results in the two interacting fields remaining totally one within the other, until the iron band member between the two interacting fields is rotably extracted, compelling the two interacting opposing flux fields to repel each other and causing the rotor assembly to push the power assembly crankshaft in the desired direction. In this manner the aforementioned repelling and attracting effects between the interacting fields experienced in the prior art, which negates rotation in permanent magnet motors, is eliminated. The present invention also provides a device to maintain the necessary coactive relationship between the opposing magnetic fields of rotor and stator magnets throughout a complete rotational cycle of the permanent magnet motor.

### BACKGROUND OF THE INVENTION

This invention is related to the field of rotational magnetically powered motors.

In the past, permanent magnet motors have met with only limited success in that they have not been self-starting and, hence, have routinely been operable only as linear motors or actuators and not as rotational devices. In fact, permanent magnet motors generally tend to be unworkable or very inefficient due to difficulties relating to the entering and exiting of one magnetic field into and from another magnetic field, resulting from magnetic repulsion or attraction between interacting fields. Such magnetic cancelling or neutralizing effects make rotational movement in the motor impossible to achieve or negligible, if achieved at all.

### SUMMARY OF THE INVENTION

It is thus an object of the present invention to overcome the limitations and disadvantages of prior permanent magnet rotational motors.

It is an object of the present invention to provide a practical, self-starting, permanent magnet, rotational motor capable of performing significant work through a rotational shaft or like drive assembly.

It is a further object of the present invention to provide a permanent magnet motor whose circumferential stator magnet segments and rotor assembly magnets can be multiplied to increase the working power of the motor.

It is still another object to provide a permanent magnet motor that will operate efficiently with state-of-the-art permanent magnets including ferrite magnets, magnets formed of ceramics, and other existing and future improved permanent magnets.

It is another object of the present invention to provide a permanent magnet motor and integrated rotor magnet movement control system that is relatively simple and feasible from a manufacturing cost standpoint.

The difficulties associated with prior permanent magnet rotational motors can be completely overcome and a fully workable permanent magnet rotary motor of a self-starting nature can be achieved. Essentially, this is accomplished in the present invention by the use of a rotating iron band member which absorbs the magnetic flux of both of the opposing magnet flux fields from stator and rotor magnets. This causes mutually opposing, interacting magnetic flux fields of the rotor and stator magnets to enter in close proximity to one another without opposition. This results in the two interacting fields remaining totally one within the other, until the iron band member between the two interacting fields is rotably extracted, compelling the two interacting opposing flux fields to repel each other and causing the rotor assembly to push the power assembly crankshaft in the desired direction. In this manner the aforementioned repelling and attracting effects between the interacting fields experienced in the prior art, which negates rotation in permanent magnet motors, is eliminated. The present invention also provides a device to maintain the necessary coactive relationship between the opposing magnetic fields of rotor and stator magnets throughout a complete rotational cycle of the permanent magnet motor.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded view of the components of the present invention.

FIG. 2 is a view of the present invention, as assembled.

FIG. 3 is an end view of the stator and rotor assembly of the present invention, with its iron band member removed.

FIGS. 4-7 are end views of the stator and rotor assembly showing the stages of a complete revolution of the iron band member and rotor assembly of the present invention, including the offset circular motion of the rotor assembly.

### DETAILED DESCRIPTION OF THE INVENTION

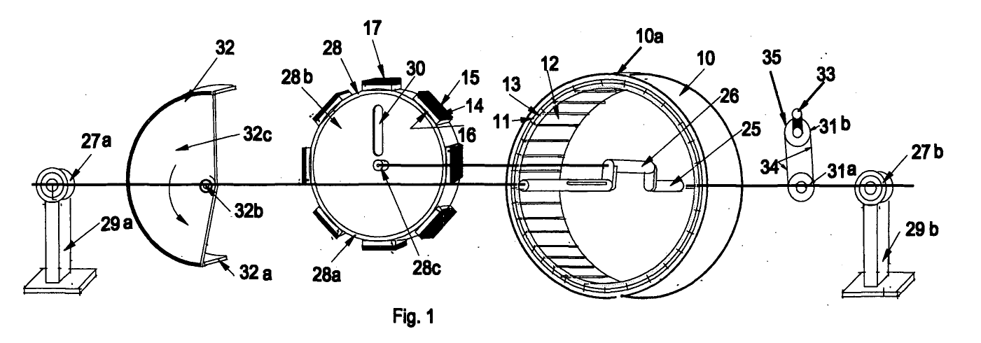

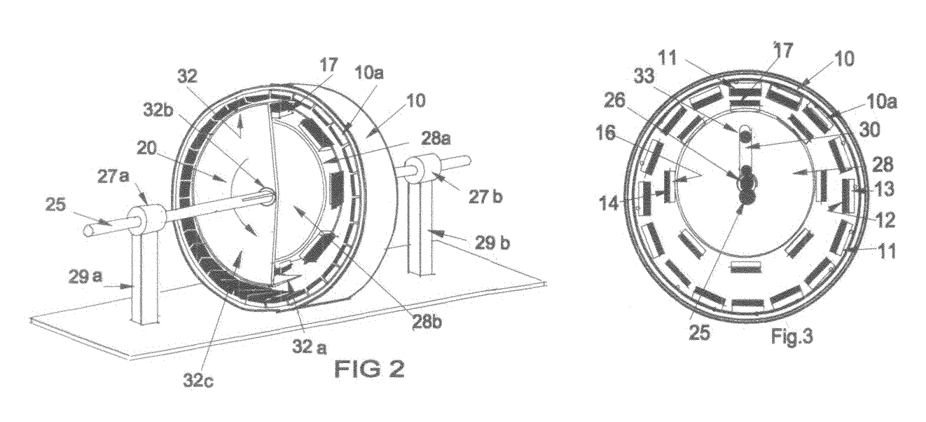

Referring to the drawings and initially to FIG. 1, the components of the motion conversion device, or the permanent magnetic rotational motor of the present invention are shown in isometric views and in exploded fashion. Iron band member 32 comprises an arcuate band component 32a with offset crankshaft attachment point 32b and protective wall 32c. Iron band member 32 is configured to rotate in the direction designated by arrow 20, shown in FIGS. 2, 4-7.

Rotor assembly 28 is circular in configuration, comprising circular outer wall 28a, protective wall 28b, journal attachment point 28c, and slot 30. Rotor magnets 14 on outer wall 28a circumscribe rotor assembly 28. Master rotor magnet 17 is positioned on the uppermost surface of wall 28a. Each rotor magnet 14, as well as master rotor magnet 17, has polarized faces 15 and 16, north and south poles, respectively.

Stator 10 is an annular body with a ring shaped outer wall 10a. Attached to and circumferentially extending around the inner surface of wall 10a is a ring of stator magnet segments 11, each magnet segment having polarized faces 12 and 13, north and south respectively.

The drive assembly of the motor extends through stator 10 and comprises journal 26 secured in offset fashion to crankshaft 25. Crankshaft 25 is maintained within support bearings 27a and 27b on stationary frame members, such as shown at 29a and 29b. Rotor 28 is secured to journal 26 at journal attachment point 28c and iron band member 32 is keyed to crankshaft 25 at crankshaft attachment point 32b.

Timing apparatus 35 comprises timing wheel 31a positioned around crankshaft 25, timing wheel 31b, timing belt 34 around wheels 31a and 31b, and timing lug 33 configured for engagement within slot 30 of rotor 28. Timing apparatus 35 maintains master rotor magnet 17 in its primary position atop rotor 28.

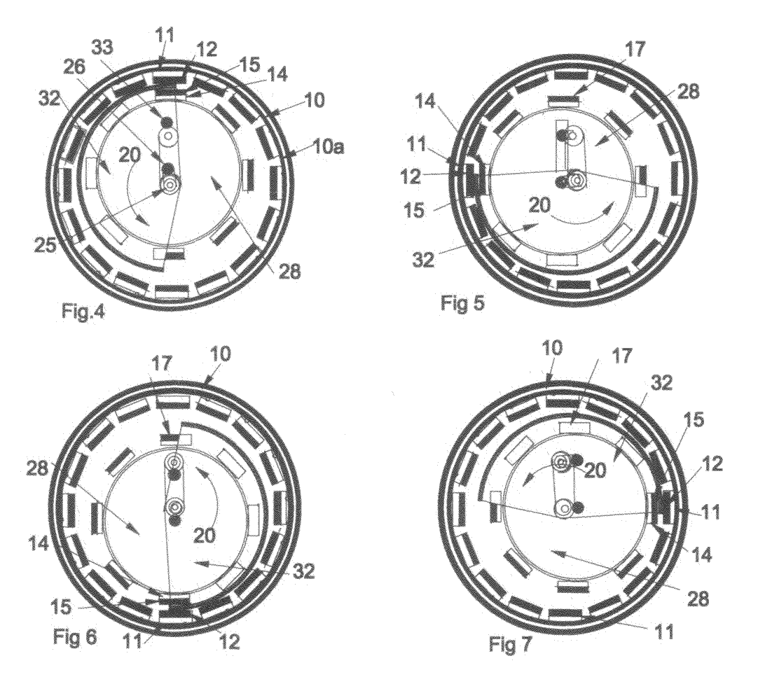

The operation of the present invention is best explained by reference to FIGS. 4-7. For purposes of demonstrating the operation of the invention only, iron band member 32 is depicted as being transparent in FIGS. 4-7. It is anticipated that iron band member 32 will ordinarily be comprised of a metal plate, as seen in FIG. 2.

As iron band member 32 revolves in the direction of arrow 20, this action exposes stator magnet segments 11 to rotor magnets 14 of rotor 28. Faces 12 of stator magnet segments and faces 15 of rotor magnets, being of like polarity, repel magnetically. Such repulsion drives rotor 28 against journal 26 in counterclockwise, offset, rotational or circular motion. This action positions rotor magnet 14 and stator magnet segment 11, as seen in FIG. 5 (showing one quarter rotation from the starting position shown in FIG. 4), in close proximity to one another, thus creating a flywheel effect on iron band member 32, which continues to expose stator magnet segments 11 to rotor magnets 14, as seen in FIG. 6 (showing one half rotation from the starting position shown in FIG. 4). The result is a continuous, counterclockwise, directional rotation of rotor 28, as seen in FIGS. 6 and 7 (one half and three quarters rotation from the starting position shown in FIG. 4). When rotor rotation has returned to its original position, shown in FIG. 4, one rotational cycle of the motor has been completed. The speed of rotation of the motor is controlled by axially adjusting iron band member 32, keyed onto crankshaft 25, between stator magnet segments 11 and rotor magnets 14.

As rotor 28 continues in a rotational cycle, timing apparatus 35 serves to maintain master rotor magnet 17 in its primary position. Timing wheel 31a, being fixedly connected to crankshaft 25, turns timing wheel 31b, being rotatably positioned on a stationary support (not shown), through rotation of timing belt 34, thereby engaging slot 30 of rotor 28 with timing lug 33, causing master rotor magnet 17 to remain in its primary position throughout the cycling of the motor.

The resulting invention is a self-starting motor which employs a magnetic propelling force, and which is capable of providing significant torque in a practical working range.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A motion conversion device comprising:
a stator having a plurality of magnet segments, each segment having an external face of like polarity;
a rotor moveably mounted to rotate in offset circular rotation within the stator, said rotor having a plurality of rotor magnets, each rotor magnet having an external face of the same polarity as the external faces of the magnet segments, the magnet segments and rotor magnets being positioned in spaced apart relation to each other, creating opposing stator and rotor magnetic flux fields; and
power means positioned between the flux fields to absorb the opposing magnetic flux fields, whereby movement of the power means through the flux fields results in the continuous offset circular rotation of the rotor.

2. The motion conversion device as in claim 1 wherein the power means comprises an iron band member extending partially around the rotor between the stator magnet segments and rotor magnets.

3. The motion conversion device as in claim 2 wherein the iron band member comprises an accurate band extending less than halfway around the rotor.

4. The motion conversion device as in claim 1 wherein the power means is rotatably mounted on a drive assembly, such that when the power means is rotatably moved between the opposing flux fields, the flux fields repel the rotor in relation to the stator, turning the drive assembly.

5. The motion conversion device as in claim 4 wherein the drive assembly comprises a crankshaft.

6. The motion conversion device as in claim 5 wherein the drive assembly comprises a journal on which the rotor is mounted.

7. The motion conversion device as in claim 1 wherein one of the rotor magnets comprises a master magnet located in spaced relation and adjacent to one of the stator magnet segments and means to maintain the master magnet in a rotatably stationary primary position in relation to the stator.

8. The motion conversion device as in claim 7 wherein the means to maintain the master magnet comprises a timing device comprising a slot within the rotor.

9. The motion conversion device as in claim 1 wherein the stator comprises a cylindrical stator ring on which the stator magnet segments are fixedly mounted.

10. A motion conversion device comprising:
a stator with an annular body, said stator comprising a plurality of stator magnets arranged internally of and circumferentially around the annular body, each stator magnet having an external face of like polarity;
a rotor assembly located within the annular body, said rotor assembly being moveably mounted to rotate in an offset circular rotation and having magnetic external faces extending circumferentially around the rotor assembly in spaced relation and adjacent to the stator magnets, the external faces of the rotor assembly having the same polarity as the external faces of the stator magnets, whereby during offset circular rotation of the rotor assembly, the faces of the rotor assembly juxtapose the stator magnets individually, one at a time, as the rotor assembly rotates.

11. The motion conversion device as in claim 10 wherein the stator magnets and magnetic external faces of the rotor assembly create opposing magnetic flux fields.

12. The motion conversion device as in claim 10 further comprising power means positioned between the opposing flux fields in a juxtapose position, said power means absorbing the opposing magnetic flux fields, whereby movement of power means through the flux fields results in the continuous offset circular rotation of the rotor.

13. The motion conversion device as in claim 12 wherein the power means comprises an iron band member extending partially around the rotor assembly between the stator magnets and external faces of the rotor assembly.

14. The motion conversion device as in claim 13 wherein the iron band member comprises an accurate band extending less than halfway around the rotor assembly.

15. The motion conversion device as in claim 12 wherein the power means is rotatably mounted on a drive assembly, whereby when the power means is rotatably moved between the opposing flux fields, the flux fields repel the rotor assembly in relation to the stator, turning the drive assembly.

16. The motion conversion device as in claim 15 wherein the drive assembly comprises a crankshaft.

17. The motion conversion device as in claim 16 wherein drive assembly comprises a journal on which the rotor assembly is mounted.

18. The motion conversion device as in claim 10 wherein one of the external faces of the rotor assembly is located on a master magnet in spaced relation and adjacent to one of the stator magnets, and means to maintain the master magnet in a rotatably stationary position in relation to the annular body of the stator.

19. The motion conversion device as in claim 18 wherein the means to maintain the master magnet comprises a timing device comprising a slot located within the rotor assembly.
